(19) United States
(12) Patent Application Publication
(10) Pub. No.: US 2007/0059133 A1
(43) Pub. Date: Mar. 15, 2007

(54) Cargo handler for vehicles with rear cargo space

(76) Inventor: Dae S. Kim, Newton, MA (US)

Correspondence Address: Dae S. Kim, 49 Floral Street, Newton, MA, 02461, US

(21) Appl. No.: 11/213,409

(22) Filed: Aug. 29, 2005

(51) Int. Cl. B60P 9/00

(52) U.S. Cl. 414/462

(57) ABSTRACT

An efficient means for loading a heavy cargo on a pallet/platform, putting the loaded platform into a flat rear cargo space of a van, mini-van, station wagon, SUV, or truck, securing the cargo in transit while protecting the floor, unloading the platform from the vehicle at the destination, moving the loaded platform on the ground and unloading the cargo off the platform uses a three-belt winch system. A matched pair is used to load and unload the loaded platform with removable casters by lifting its front end over the rear bumper, tipping to level and sliding into the securing position for traveling. The third belt is used to unload the platform and load the cargo onto the platform.

### BACKGROUND OF THE INVENTION

1. Field of the Invention

This invention relates to a device and method for loading a cargo into a vehicle with a flat rear cargo space, securing the cargo while transporting, unloading the cargo at the destination and moving the cargo on the ground.

More specifically, this invention relates to a platform truck that converts into a pallet that loads, unloads and secures a heavy cargo into any flat rear cargo space of a van, mini van, station wagon, SUV, small truck with a removable rear gate or truck.

2. Descriptions of the Prior Arts

Prior art cargo handlers can be grouped into two general types. One is a distinct and separate wheeled or tracked vehicle with means of lifting/lowering a cargo and the other type is a device attached to or/and carried on a vehicle.

The first type includes large container handling systems, forklift trucks, small hand pallet lift trucks and mobile conveyor belts. Among them, forklift trucks are most popular for handling a variety of cargo for different types of carriers. Although some larger trucks carry a forklift truck for unloading at the destination, most forklift trucks stay at either end of the trip. For efficient uses of forklift trucks, cargo is pre-loaded on a pallet. Sometimes, large trucks carry a pallet truck that has only limited lifting capability for moving or re-arranging cargo within the truck.

The second type includes lift gates, movable or folding ramps, swing boom winches and custom designed devices for wheel chairs or other smaller vehicles, such as gardening equipment, recreational vehicles or two-wheelers.

The first type prior art cargo-handling devices are industrial in nature and expensive to buy and maintain. The second type prior art devices are also costly and designed for only limited application. Neither type of devices are suitable for general use by the general public or small business owners who own extremely popular vans, mini-vans, station wagons, SUVs or small trucks. It is highly desirable to provide them a simple device which lets a single person handle as much as a ton of cargo.

### SUMMARY OF THE INVENTION

This invention provides an efficient means for loading a cargo on a pallet/platform, putting the loaded platform into a flat rear cargo space of a van, mini-van, station wagon, SUV, small truck with a removable rear gate or truck, securing the cargo in transit without damage to the floor, unloading the platform off the vehicle at the destination, moving the loaded platform on the ground and unloading the cargo off the platform.

This invention makes every vehicle with a flat rear cargo space a safe and energy efficient cargo carrier for small businesses and do-it-yourselfers. As more than half of all new passenger vehicles have a large rear cargo space, their newly expanded use should bring enormous saving in energy, time and money with this complete cargo handler.

In this invention, a sturdy substantially rectangular platform, with smooth but tough surfaces, serves as a pallet. On its top surface, a heavy cargo is slid and secured and its bottom surface slides on and protects the floor of the vehicle during loading, moving and unloading. Although the available cargo space and the rear opening varies widely and limits the maximum size of platform for each vehicle, several select sizes and shapes should cover most vehicles.

For ground mobility, four readily removable wheels/casters, a pair of fixed type on one end and a pair of swivel type at the other end, are attached near the four corners so that this platform becomes an easy handling platform truck on the ground. The casters or wheels are removed when they are lifted off the ground and not needed.

In this invention, unlike any prior art cargo loaders, the front end of the cargo laden platform is lifted or lowered over the rear bumper area of a vehicle with a pair of matched belts which are adjustably connected to a common shaft of a winding winch. The shaft is supported by three channel-shaped columns, a matched pair at near the rear corners of the platform and another, in the middle. The winding pair of belts pushes the platform into the cargo space by sliding over the rear bumper. When the center of gravity of the loaded platform reaches near the top of the contacting area, the rear end of the platform is lifted off the ground by simply tipping up to level with very little effort. To reduce the contact pressure, a strip of carpet covers the contact area over the rear bumper under the belts. Further winding pushes the platform to its traveling position for securing.

In this invention, the third belt is also adjustably connected to the middle of the shaft. The winding direction of the middle belt can be either opposite or the same of that of the pair. The pair of belts slides under and supports the smooth bottom side of the platform and firmly tied to the floor of cargo space for lifting the front end of the platform but the middle belt is routed to the topside and can go either direction, forward for pulling a cargo onto the platform by tying it to the cargo or backward for pulling the loaded platform off the vehicle by tying its free end to a fixed object on the ground. An additional means of adjusting its length keeps the belts tight for a safe unloading.

To pull the cargo onto the platform with the middle belt, the front casters are removed and the back end of the cargo is lifted onto the front end of the platform. When the rear part of the cargo reaches the column(s), the cargo is anchored down on platform against the column(s) with a rope or a belt. For unloading the cargo, the front casters are replaced with a pair of thin strips of wood to keep the belts off the ground and the free ends of the pair of belts are tied around the rear of the cargo to pull it forward off the platform. The inclined platform allows gravity to help in pushing the cargo off. To lift one end of the cargo or the front end of the platform for removing or re-mounting the wheels on the ground, a tire iron or a similar lever and a pivoting block are used.

In securing a loaded platform for traveling, the safest way is to use the recessed seat anchors. One or more pairs of cross-bars and J-rods can hold down the both long sides of the platform. This is a common automotive practice in securing a part, such as a spare tire or battery. When seat anchors are not readily accessible, one can use the front seat base and other usually available anchors which are connected to chassis or frame.

Although the maximum height of the columns is limited by the rear door opening of the cargo space, the shaft is high enough to be a comfortable handle bar for the platform trucking. Four U-shaped smooth metal plates cover and re-enforce the corners to provide bases for anchors and casters. The front pair protrudes to clear the usually bowing mid-part of rear bumper while lifting and holds the cantilever axles of fixed front wheels for more clearance. The rear pair provides bases for the outer columns and a sufficient distance between the columns and rear casters to prevent the loaded platform from flipping before the tipping. For an added safety, the casters are locked in their rear most position. For compact storage, the columns and winch system are made removable.

### BRIEF DESCRIPTION OF THE DRAWINGS

The present invention will be understood better by reading the following description and accompanying drawings wherein:

FIG. 1 is a perspective view of this invention.

FIG. 2 is an enlarged detail of the front left corner of the platform.

FIG. 3 is an enlarged detail of the right rear part of this invention.

FIG. 4 is a side view of a cargo being slid onto the platform.

FIG. 5 is a side view of a cargo secured on the platform for ground movement.

FIG. 6 is a side view of the front of the platform being lifted.

FIG. 7 is a side view of the platform in the vehicle ready for tipping.

FIG. 8 is a side view of the platform after the tipping.

FIG. 9 is a side view of the platform being pulled out of the vehicle.

FIG.10 is a side view of a cargo being slid off the platform.

### BEST MODE FOR CARRYING OUT THIS INVENTION

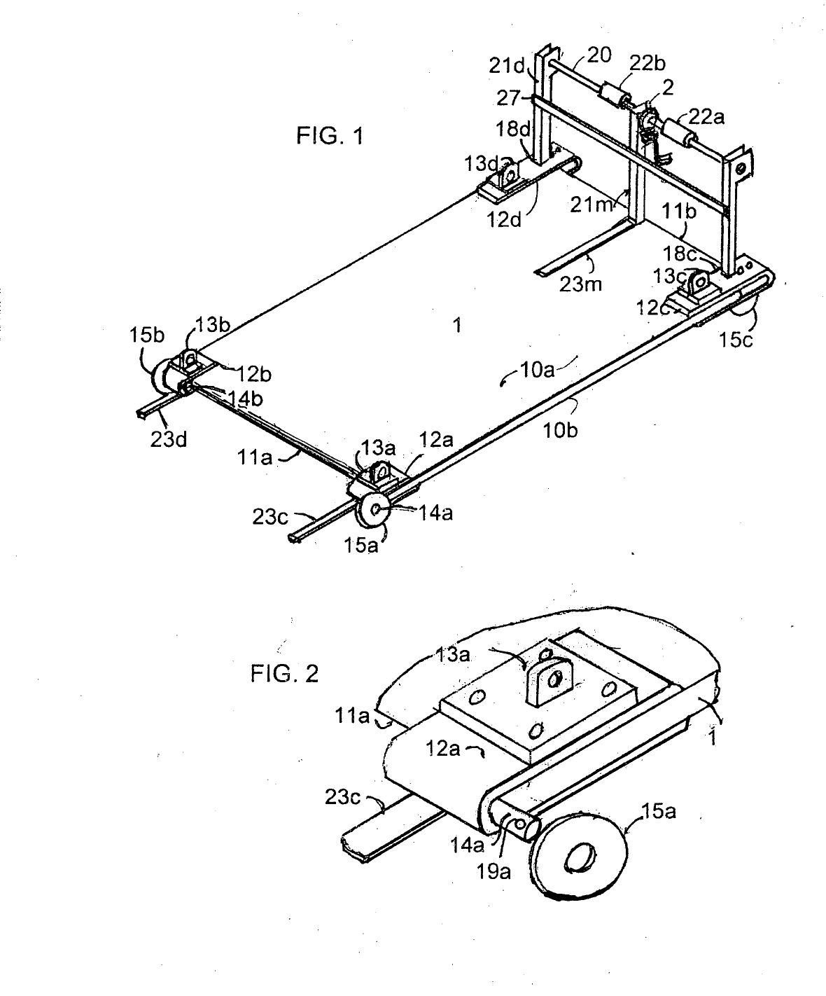

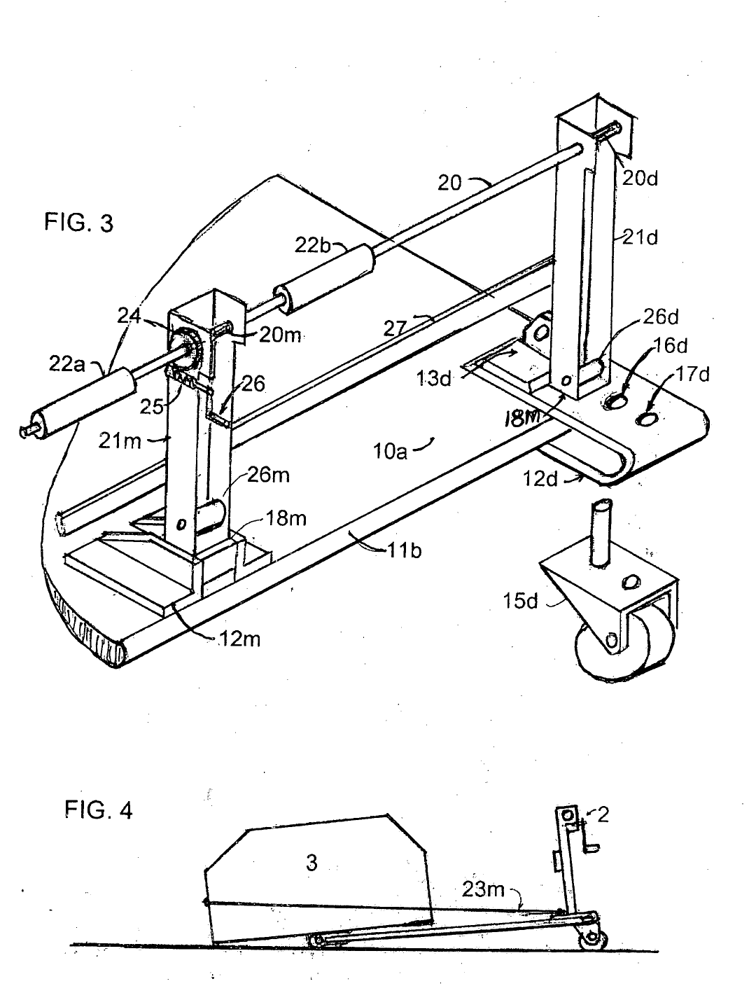

In FIG. 1 and details in FIG. 2 and 3, a ¾″ thick rectangular plywood platform 1 has smooth but tough top 10a and bottom 10b surfaces and rounded front end 11a and rear end 11b for easy sliding. Its four corners are re-enforced and covered by 3/16″ thick, 4″ wide U-shaped metal plates 12a, 12b, 12c and 12d with cargo holding anchors 13a, 13b, 13c and 13d. The front plates 12a and 12b hold cantilever axles 14a and 14b with retainer-pin holes 19a and 19b (not shown) near the end for removable wheels 15a and 15b. Also the rear plates 12c and 12d have square openings 18c and 18d for holding the outer columns 21c and 21d of three-post winch system 2, holes 16c and 16d for holding the mounting shafts of removable swiveling casters 15c and 15d and holes 17c and 17d for removable pins which hold the casters at their rear most positions for safety while the front end 11a is lifted. Each plate and anchor are attached to the platform with a set of four 5/16″ counter sunken flat head screws, which thread up into the tapped holes on the base of anchor. The polished flat bottom surfaces of the plates slide and support the platform on the floor of cargo space with little pressure. This design can handle wide selections of platform size, wheel/caster size, and floor anchor position for many different vehicles with minimal modification of fabricated metal parts and tooling cost.

The winch system 2 has a tubular winding shaft 20 with a pair of tubular elastic grips 22a and 22b for a platform trucking handle bar and three substantially rectangular diametric slots 20c (not shown), 20d and 20m between the flanges for adjustably holding the belts 23c, 23d and 23m and is supported by three channel shaped columns 21c, 21d and 21 m which guide and protect the belts. The top portions of the columns have wider flanges to provide sufficient room for the wound belts and holes for the shaft 20. The right flange of the middle column 21m is even wider to support a worm gear assembly which consists of a 5″ worm wheel 24 attached to the winding shaft 20, a worm 25 mounted on the flange and removable crank 26. As the worm 25 eliminates ratchets and takes little cranking torque, one can simply turn it with a portable electric drill with ease.

The outer columns 21c and 21d are identical and are held in the openings 18c and 18d of the metal plates 12c and 12d. At the bottom of the columns 21c and 21d rollers 26c (not shown) and 26d guide the belts 23c and 23d forward under the platform 1. The middle column 21m is held in the opening 18m and a roller 26m guides the middle belt 23m either forward over or rearward away from the platform 1. The plate 12m is made by joining a pair of angles and a pair of flats and has the opening 18m for the column 21m, sluts for the belt 23m and a pair of horizontal flanges for mounting on the platform 1. A brace 27 ties the columns and fences the cargo. The columns can be easily unlocked and removed for compact storage or carrying.

The remaining figures describe stepwise operation of this invention.

In FIG. 4, the rear of a heavy cargo 3 is lifted on the front 11a of the platform 1 as the front wheels 15a and 15b are temporally removed. The end of the center belt 23m is tied to the cargo 3. The center belt 23m pulls the cargo 3 to the columns by winching.

In FIG. 5, after the belt 23m is removed and the cargo 3 is secured on the platform 1 by a rope/belt 30, the front casters 12a and 12b are re-mounted for ground movement.

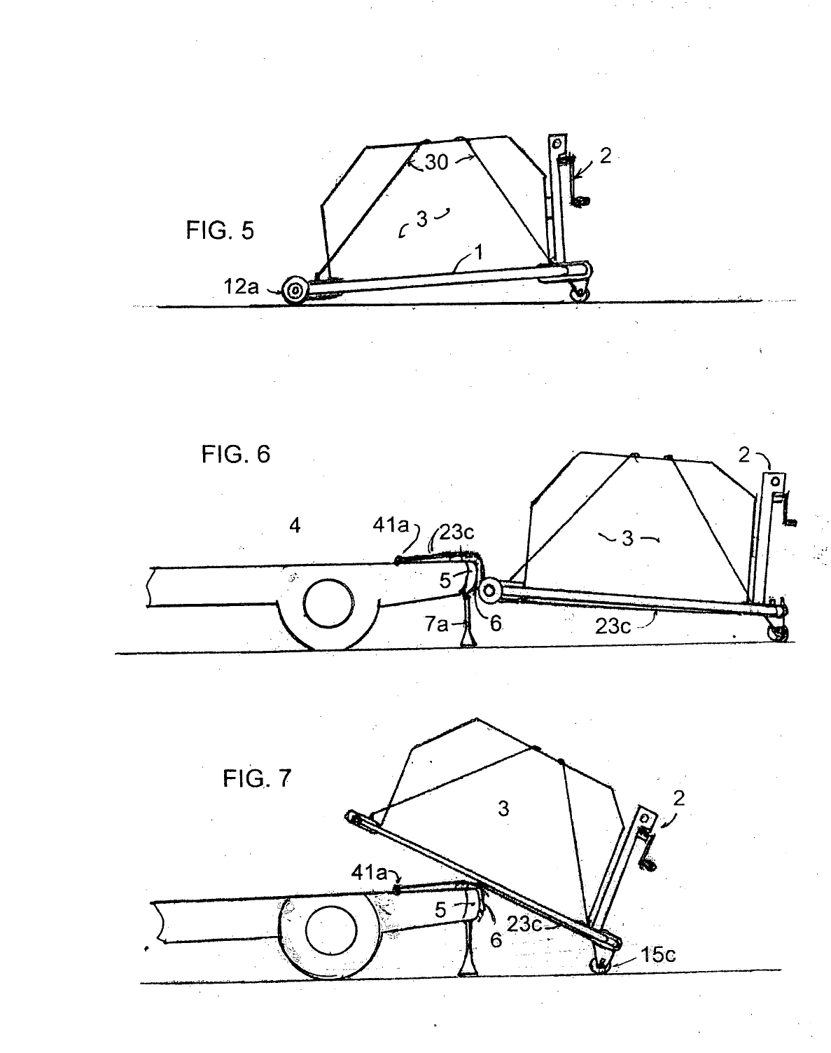

In FIG. 6, the rear casters 15c and 15d are locked in their rear most position. the protective cover 6 and bumper supports 7a and 7b (not shown) are in place before loading. The pair of lifting belts 23c and 23d is securely connected to a pair of anchors 41a and 41b on the floor of the cargo space 4. Also the front end 11a is partially lifted off the ground by winding the pair of belts 23c and 23d and the front wheels 12a and 12b are about to contact the rear bumper 5. During this lifting each belt needs to carry about one fourth of the weight of the cargo. Widely available Nylon web 1.0″×0.025″ is rated to carry more than one thousand pounds, which amount to two tons of cargo and is far too much for most of passenger vehicle or small truck to carry. Further winding lifts the front-end 11a over the bumper 5, which is partially covered by a strip of carpet 6 to protect the bumper 5 and to improve the sliding. Although most bumpers can withstand full weight of cargo, a pair of removable vertical supports 7a and 7b prevent bottoming and lessen the stress to bumper, rear suspension and tires. They are slightly shorter than the bumper to ground clearance of fully loaded vehicle so that it can be easily placed and removed when the loading is finished.

In FIG. 7, the front wheels 15a and 15b are removed. At this point, most of weight of the cargo 4 is on the rear bumper 5. A gentle tipping of the platform 1 to level by lifting its rear end 11b avoids a sudden tipping and requires very little effort.

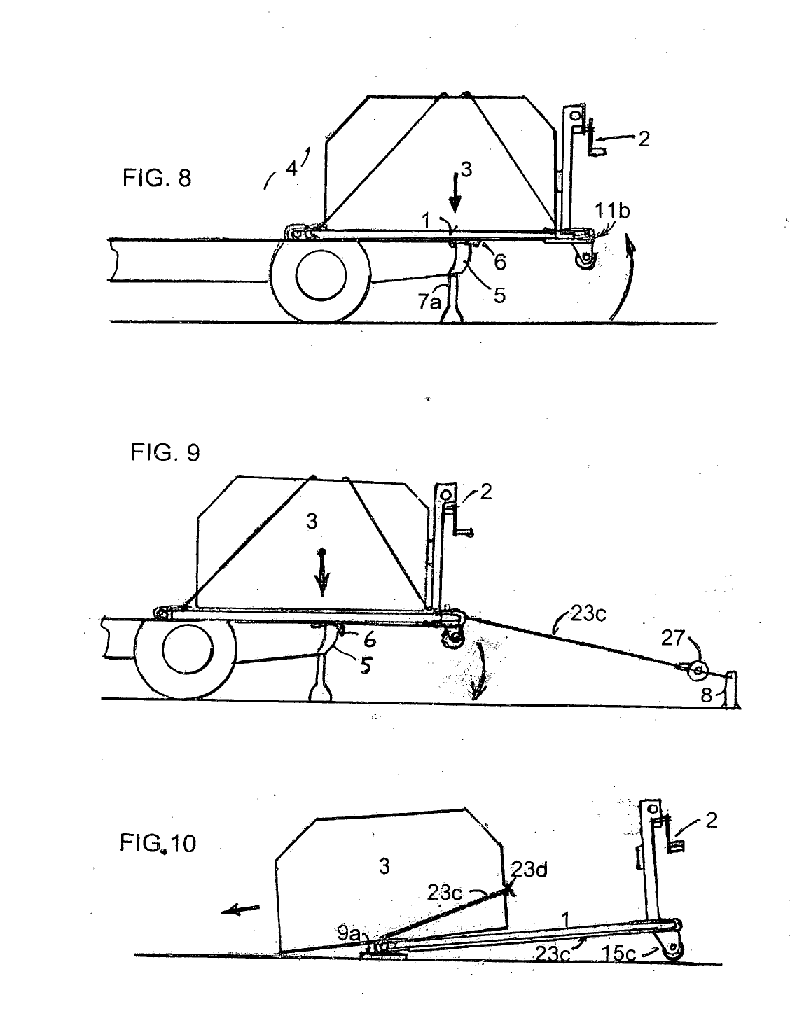

In FIG. 8, the rear casters are removed. Further winding slides the platform 1 into the traveling position and securing for travel. The supports 7a, 7b and cover 6 are removed for uses at the destination. At the destination, the unloading process is essentially the reverse of thus described loading process except some safety measures.

In FIG. 9, the platform is pulled out of the cargo space 4 by winding the middle belt 23m whose adjustable free end is securely tied to a fixed object 8 on the ground. As the belt 23m winds, the pair 23c and 23d unwind disproportionately due to the difference in wound diameters. A ratchet winder 27 is used to keep all belts tight. Before tipping down, the rear casters 12c and 12d are re-attached and the front wheels 12a and 12b after tipping. When the belts 23c and 23d support the front end 11a the center belt 31c is no longer needed. When front wheels touch the ground, all three belts are loosened and untied. The pallet converts to a platform truck which is ready for ground movement.

In FIG. 10, the front wheels 12a and 12b are replaced with a pair of wooden strips 9a and 9b, to keep the belt off the ground. The free ends of the belts 23c and 23d are tied around the backside of the cargo 3, which is pushed forward off the platform 1.

It is understood that the above description is given merely as illustration and not in limitation of the invention and that various modifications may be made thereto without departing from the spirit of the invention as claimed.

I claim;

1. A device and method for loading a cargo into a vehicle with a flat rear cargo space, securing said cargo while traveling, unloading said cargo at the destination and moving said cargo on the ground comprising;
a. a substantially rectangular platform with smooth but tough surfaces, means of securing said cargo on said platform and also a means of securing said platform loaded with said cargo in said cargo space for traveling,
b. a removable means of supporting and moving said platform on the ground,
c. a means of lifting or lowering the front end of said platform over the rear bumper area of said vehicle and sliding said loaded platform into said cargo space and
d. a means of pulling said cargo onto said platform and pulling said loaded platform out of said cargo space.

2. The device of claim 1 wherein said means of securing said cargo is a rope or ratcheted belt, two or more pairs of anchors on the top surface along both sides of said platform, three perpendicularly mounted columns, a pair at the corners and one in the middle, along the rear part of said platform and one or more horizontal brace connecting said columns.

3. The device of claim 1 wherein said means of securing said platform is sets of connectors holding said platform to anchors on the floor of said cargo space.

4. The device of claim 1 wherein said removable means is a pair of removable wheels supporting the front corners and a pair of removable swivel casters supporting the rear corners of said platform.

5. The device of claim 1 wherein said means of lifting or lowering is a means of controllably winding and unwinding a pair of matched belts whose one ends are adjustably connected to a common shaft of a winch mounted on the top part of said columns and the other ends are connected securely to the floor of said cargo space while sliding under said platform and tipping said loaded platform by lifting said rear end to level when the center of gravity of said loaded platform is near the top of said bumper.

6. The device of claim 1 wherein said means of pulling said cargo is a belt adjustably connected to middle of said common shaft and routed to the top side of said platform for pulling said cargo onto said platform by connecting the free end to said cargo or routed to the opposite direction away from said vehicle to a stationary object on the ground with an additional means of controlling the length of said belt to apply tension for a safely pulling said platform out of said cargo space.

7. The device of claim 6 wherein said means of controlling the length is a simple ratchet winder near said free end.

8. The device of claim 5 wherein said means of controllably winding is a worm gear winch having a worm wheel attached to the said winding shaft and worm driven by a removable handle and mounted on an enlarged flange of one of said three columns.

9. The device of claim 8 wherein said three column is removable for storage.

10. The device of claim 1 wherein said rear bumper area is supported by a pair of legs below for a safe bottoming and protected by a cover for minimizing contact pressure and for ease of sliding on top.
